(19) United States
(12) Patent Application Publication
(10) Pub. No.: US 2012/0112033 A1
(43) Pub. Date: May 10, 2012

(54) METHOD FOR KEEPING A TRANSPORTABLE MAST UPRIGHT DURING ERECTION OR RETRACTION THEREOF, AND MAST ASSEMBLY

(75) Inventor: Edmond Oyen, Zutendaal (BE)

(73) Assignee: SECOBEL, Genk (BE)

(21) Appl. No.: 13/319,944

(22) PCT Filed: May 11, 2010
(86) PCT No.: PCT/EP2010/056493

§ 371 Date: Jan. 20, 2012

(30) Foreign Application Priority Data
May 11, 2009 (EP) PCT/EP2009/055683

(51) Int. Cl. E04H 12/22; F21V 21/00; G10G 5/00; H01Q 1/12; G03B 17/56

(52) U.S. Cl. 248/523

(57) ABSTRACT

The invention relates to a method for keeping a mast upright during erection or retraction thereof, the mast being part of a mast assembly additionally comprising a base and a guy control assembly, which guy control assembly allows to keep guy control wires under tension by a single person.

The invention also relates to a mast assembly comprising the mast, the base, and a guy control assembly for keeping the mast upright during erection or retraction of the mast.

### FIELD OF THE INVENTION

The invention relates to a method for keeping a transportable mast upright during erection or retraction thereof.

The invention also relates to a mast assembly comprising a mast, a base, and a guy control assembly.

### BACKGROUND OF THE INVENTION

Transportable masts are known in the art, and are for example used for supporting and orienting temporary transmitting and/or receiving antennas, for both military and civilian purposes, at a distance above the ground of e.g. 2 to 25 meters.

Transportable masts of this kind are usually constructed using a tripod with a circular upright opening, in which a first tubular element is inserted in an upright position. An antenna is attached to the top of this first tubular element. Then the first tubular element is lifted together with the antenna, so that a second tubular element can be inserted underneath the first tubular element. The top of the second tubular element engages the bottom of the first tubular element, and so on.

### PRIOR ART DESCRIPTION

U.S. Pat. No. 4,212,015 describes a portable radio link system mast. FIG. 1 shows a stand with mast tubes and guy ropes which lead to a rope winder over guide pulleys with which the ropes can be tightened individually or together. The ropes can be fastened to the anchoring points and tightened by hand, or be wound to rope reels to wind the ropes. A disadvantage of this system is that the rope winder and rope reels are slow to handle and easily get blocked by sand or dirt.

In other mast systems without such a rope winder, typically three people standing around the mast are holding the ropes during erection or retraction of the mast. A disadvantage of such a method is that it requires more people during the set-up of the mast, and that it is very difficult to keep the mast stabilized without causing oscillations of the mast.

### DESCRIPTION OF THE INVENTION

It is an aim of the present invention to provide a mast assembly comprising a mast, a base, and a guy control assembly with which the mast can be kept upright during erection or retraction thereof. This aim is achieved according to the invention with a mast assembly showing the technical features of claim 1.

Thereto, the mast assembly according to the present invention comprises a base and a transportable mast and a guy control assembly for stabilizing the mast during erection or retraction of the mast, the mast comprising a plurality of tubular mast elements positioned on top of each other; the base comprising:-a guide shaft with an opening for guiding the displacement of the tubular mast elements during erection or retraction of the mast;-a plurality of legs connected to the guide shaft, for positioning the guide shaft at a distance above ground to allow insertion of the tubular mast elements from a position below the guide shaft; the guy control assembly being connected to the mast at a predefined position T in at least three directions by means of at least three guy control wires, a first end of each guy control wire being connected to the mast, a second end of each guy control wire being connected to the guy control assembly, each guy control wire being guided at a position between the first and second end of the guy control wire towards a ground position X, Y, Z located at a distance R and being separate from the base, to which ground positions X, Y, Z they are fastened or from which ground positions they are routed further to a single position P to permit keeping the guy control wires under tension by a single person, and wherein the guy control assembly is portable by a single person and has at least one handle for holding the guy control assembly. By providing a portable guy control assembly, whereto second ends of the guy control wires are connected, the guy control wires can be kept under tension by a single person. The tightening or relaxing of the guy control wires occurs by simply walking towards or away from the base, which can happen fast. By providing a guy control assembly having at least one handle, the single person can firmly hold the guy control assembly in one hand, thereby keeping the guy control wires under tension, while being able to adjust the position of one of the guy control wires with his other hand. By keeping the guy control wires under tension by moving towards or away from the base, a guy control assembly with moving parts can be avoided, thus providing a more reliable system, which is less vulnerable to dust or sand. This is especially important in military applications. The inventor has found that by routing the guy control wires from the predefined position T on the mast, to the ground positions X, Y, Z at a predefined distance R and separate from the base, instead of routing them towards the legs of the base, the guy control wires can be located away from the base, in such a way that that the person standing near the base for lifting the mast, getting additional mast elements and inserting them into the base is not obstructed by the guy control wires. This greatly reduces the time required for setting-up the mast, but also improves the safety of the personnel and equipment on and near the mast, and it reduces the number of accidents and the resulting down-time which can cost large amounts of money.

Preferably the ground positions X, Y, Z are located on an imaginary circle of a predefined radius R, where the base is standing in a centre of the circle. Using such positions provides for a uniform tension in the guy control wires.

Preferably the radius (R) is chosen such that an angle β between a ground surface and the guy control wires is between 45 and 60 degrees when the mast is fully erected. This gives a good compromise between stability of the mast, and a reasonable area occupied by the mast assembly.

Preferably the ground positions X, Y, Z are lying 120 degrees apart on the imaginary circle. This gives an optimal distribution of the ground positions for pulling the mast in three directions for holding it upright.

Preferably the guy control wires are routed from the ground positions X, Y, Z to one of the ground positions Y before being routed further to the single position P. By doing so the forces exerted upon the person holding the guy control assembly are oriented in only one direction which makes it easier and more reliable to hold the guy control assembly because the person is not pulled sideways when the wind pushes the mast in one direction. Instead, the person only has to move towards or away from the base for keeping the guy control wires under tension and is not surprised by a sideways movement. In addition, the tension exerted upon the guy control wires becomes substantially independent of the position of the person with respect to the base, thereby keeping the mast substantially upright even if the person moves slant towards or away from the base.

Preferably the guy control assembly comprises rope cleats whereto the second ends of the guy control wires are connected. The inventor has found that rope cleats are extremely suitable means for releasably connecting or releasing the second ends of the guy control wires to or from the guy control assembly. This allows the guy control wires to be easily connected, or released, or adapted from the guy control assembly using only one hand, so that the other hand can be used for holding the guy control assembly at a position above the ground.

Preferably the guy control assembly has three handles, a left handle, a right handle and a lower handle, for holding the guy control wires under tension, or for adjusting a guy control wire. The central position of the lower handle is especially useful for holding the guy control assembly with one hand, while placing the guy control wires on the guy control assembly by the other hand, or for adjusting the position of one of the guy control wires while keeping the other guy control wires under tension. The left and right handles are especially handy for firmly holding the guy control assembly with both hands.

It is also an aim of the present invention to provide a method for keeping a transportable mast upright during erection or retraction thereof, which method is fast and requires only one person. This aim is achieved according to the present invention by a method showing the technical features of the independent claim 14.

Thereto the method for keeping a transportable mast upright during erection or retraction thereof, according to the present invention, the mast being part of a mast assembly that also comprises a base and a portable guy control assembly, the mast comprising a plurality of tubular mast elements positioned on top of each other; the base comprising: —a guide shaft with an opening for guiding the displacement of the tubular mast elements during erection or retraction of the mast;-a plurality of legs connected to the guide shaft for positioning the guide shaft at a distance above ground to allow insertion of the tubular mast elements from a position below the guide shaft; the method comprising the steps of:-connecting first ends of at least three guy control wires to the mast at a predefined position T in at least three directions;-guiding each guy control wire towards a ground position X, Y, Z located at a predefined distance R and separate from the base, and routing them further to a single position P to permit keeping the guy control wires under tension by a single person;-connecting a second end of each guy control wire to the guy control assembly;-keeping the guy control wires under tension by holding the guy control assembly while moving towards resp. away from the base as the mast elements are being lifted resp. lowered. By connecting the guy control wires in three directions and routing them to ground positions X, Y, Z at a (minimum) predefined distance R from the base, a stable position of the mast can be obtained. By routing them to a single position P, the three wires can be held by a single person. By connecting the second ends of the guy control wires to the portable guy control assembly, a firm holding of each of the guy control wires is provided, and their relative position can be better adjusted. By moving towards or away from the base, the three guy control wires are simultaneously released or pulled, allowing the mast to be quickly lifted or lowered while keeping the mast upright. As the guy control assembly has no moving parts, and is typically held by a person above the ground, sand or the like cannot block the system.

### LIST OF THE FIGURES.

The invention is further elucidated in the appending figures and figure description. Note that the figures are not drawn to the scale. The figures are intended to describe the principles of the invention.

FIG. 1A shows a view to a preferred embodiment of a base of the mast assembly according to the present invention.

FIG. 1B shows a close-up view to the guide shaft of the base of FIG. 1A.

FIG. 1C shows an example of a hinge pin with two circlipses.

FIG. 2A shows the base of FIG. 1A in an extended position, whereby the legs are maximally unfolded.

FIG. 2B shows the base of FIG. 2A, whereby the legs are partly folded, partly unfolded.

FIG. 2C shows the base of FIG. 2A in a retracted position, whereby the legs are maximally folded.

FIG. 2D shows another preferred embodiment of a base for a mast assembly according to the present invention.

FIG. 2E shows a cross section of the base of FIG. 2F in plane A-A.

FIG. 2F shows a base with a graduated collar.

FIG. 3A shows a preferred embodiment of the tubular pipe of the base of FIG. 1A.

FIG. 3B shows a preferred embodiment of the first leg attachment collar of the base of FIG. 1A.

FIG. 3C shows a preferred embodiment of the leg guide collar of the base of FIG. 1A.

FIG. 3D shows a preferred embodiment of the first circlips of the base of FIG. 1A.

FIG. 3E shows a preferred embodiment of the second circlips of the base of FIG. 1A.

FIG. 4A shows the tubular pipe of FIG. 3A in side view.

FIG. 4B shows the tubular pipe of FIG. 4A over which a first leg attachment collar is shifted until it touches the tubular pipe collar.

FIG. 4C shows the tubular pipe of FIG. 4B after mounting of the first circlips.

FIG. 4D shows the tubular pipe of FIG. 4C over which a leg guide collar is shifted.

FIG. 4E shows the tubular pipe of FIG. 4D after mounting of the second circlips.

FIG. 4F shows an alternative embodiment of the tubular pipe of the base of FIG. 1A.

FIG. 5A shows a partly erected antenna mast.

FIG. 5B shows a guy collar assembly.

FIG. 5C shows a lifting block assembly

FIG. 5D shows an example of how a guy control wire is mounted to the guy collar assembly.

FIG. 6A shows an example of a tubular mast element.

FIG. 6B shows the upper and lower part of the tubular mast element of FIG. 6A.

FIG. 6C shows another example of a tubular mast element.

FIG. 7A shows a perspective view on a mast assembly according to the present invention, whereby the antenna mast is fully erected.

FIG. 7B shows a close-up view of the connections to a picket.

FIG. 7C shows a close-up view of the connections to the control picket.

FIG. 7D shows a close-up view of a preferred embodiment of the guy control assembly.

FIG. 8A shows a detailed view of the guy control assembly of FIG. 7D.

FIG. 8B shows a close-up view of an example of a guy control wire.

FIG. 9A shows a perspective view on a field base of an embodiment of the present invention.

FIG. 9B shows a cross section of the field base of FIG. 9C in plane B-B.

FIG. 9C shows a top view of the field base of an embodiment of the present invention.

FIG. 9D shows an example of how a bottom element can be fixed in a field base that can be used in the mast assembly of the present invention, using a first and a second fixation means which are different from each other.

FIG. 9E shows an example of how a bottom element can be fixed in a field base that can be used in the mast assembly of the present invention, using a first and a second fixation means which are the same.

### DETAILED DESCRIPTION OF PREFERRED EMBODIMENTS

The invention relates to a mast assembly 47 comprising a transportable mast 2, a base 1, and a guy control assembly 28, and to a method for keeping a transportable mast 2 upright during erection or retraction of the mast 2.

Several transportable masts are known in the art, and they are used for different purposes. The masts 2 aimed at by the present invention are typically 2-15 m, or 2-25 m, or any other height. The mast 2 can be a sectional mast. The mast 2 usually comprises a plurality of superimposed tubular mast elements 4 of a constant outer diameter D, on top of which equipment 8 can be mounted that needs to be positioned at a predetermined height and optionally also directed in a predetermined orientation, such as e.g. an antenna, a camera, a microphone, or lighting. The rest of the description will usually describe an antenna mast, but the invention is not limited thereto.

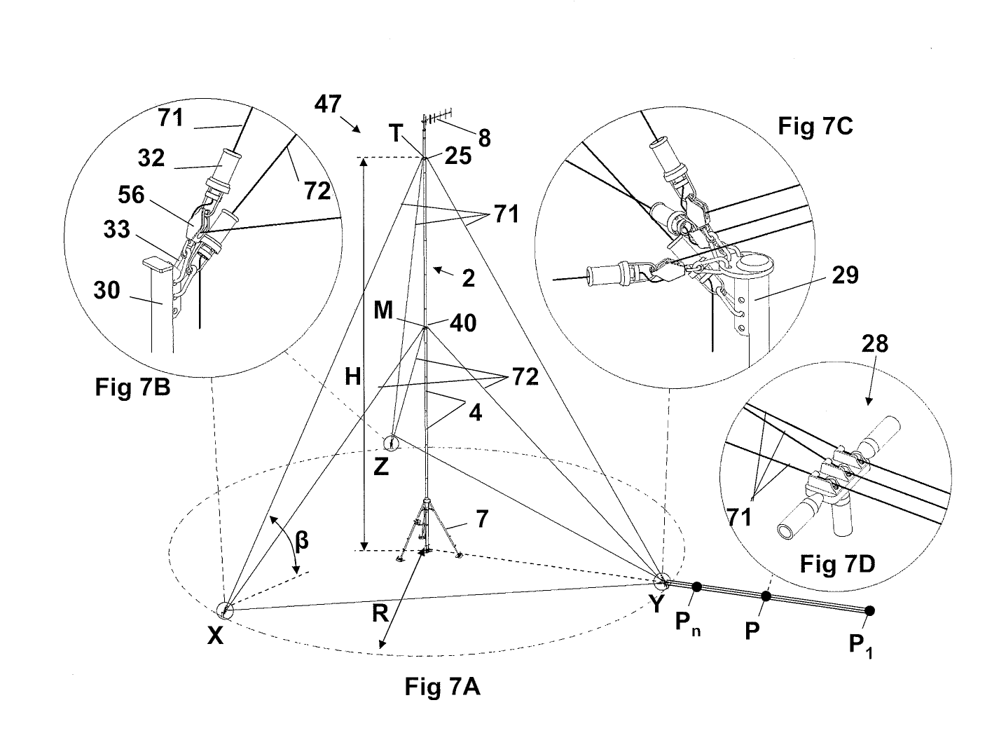

The transportable mast 2 is supported by a base 1 (also known as a tripod), and held in position by guy control wires when fully erected, as shown in FIG. 7A. However, before explaining how such a mast 2 is set-up, a preferred embodiment of a base 1 for such a transportable mast 2 is explained in detail.

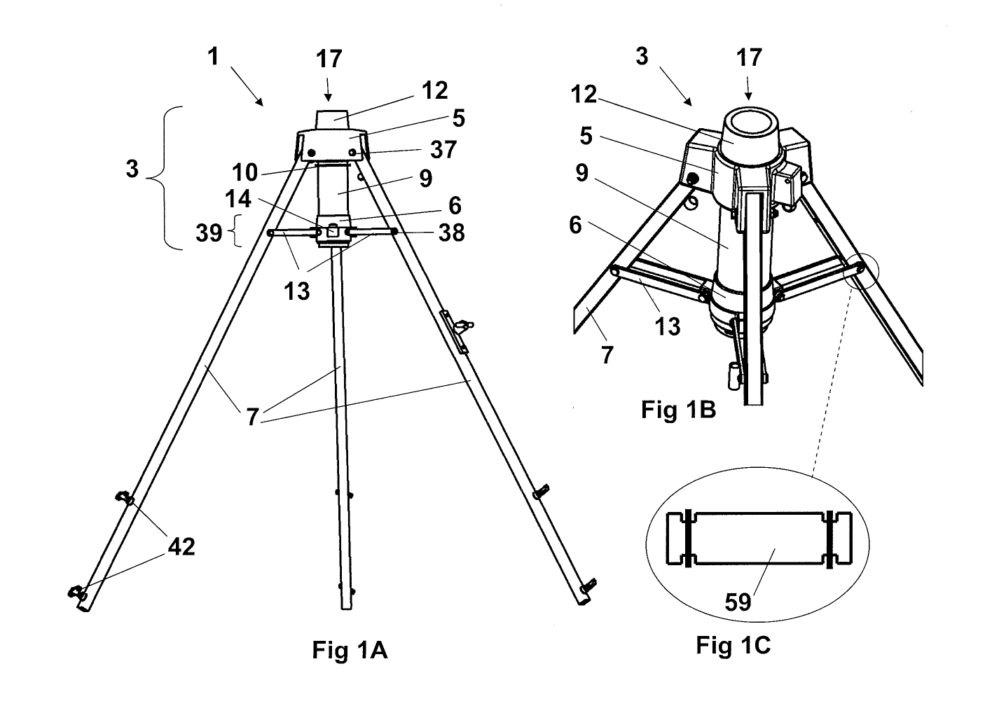

FIG. 1A shows a preferred embodiment of a base 1 for the mast assembly 47 of the present invention.

FIG. 1B shows the base 1 of FIG. 1A in more detail. The base 1 comprises a guide shaft 3 which comprises several parts: a tubular pipe 9, a first leg attachment collar 5 mounted to an upper part of the tubular pipe 9, and a plurality of legs 7 for supporting the mast on a positioning surface e.g. the ground, connected to the tubular pipe. With “mounted to” is meant that the first leg attachment collar 5 can e.g. be mounted on top of, against or around the tubular pipe 9. Preferably the base 1 also comprises a leg guide collar 6 to provide a second connection between the tubular pipe 9 and the legs 7.

The tubular pipe 9 is made of a first material, the first leg attachment collar 5 of a second material, and the leg guide collar 6 of a third material, whereby these materials can all be different, or all be the same, or some of them can be the same. For example, the collars 5 and 6 could be made of the same material while the tubular pipe 9 is made of a different material, or the tubular pipe 9 and the first leg attachment collar 5 could be made of the same material, while the leg guide collar 6 is made of a different material, or the tubular pipe 9 and the leg guide collar 6 could be made of the same material while the first leg attachment collar 5 is made of a different material.

In a preferred embodiment of the present invention the first, second and third material have a mass density between 1.0 and 3.0 kg/dm³. Using materials with a low mass density provides a lightweight guide shaft 3, which is easy to produce. A base 1 comprising this guide shaft 3 is easy to transport and can be easily set-up by only one person.

In a preferred embodiment of the present invention the first material is a plastic material, such as e.g. POM, and the second and third material are aluminum or an aluminum alloy. By using these materials, the dynamic friction between the tubular pipe 9 and the tubular mast elements 4 which are usually made of aluminum can be minimized when the mast elements 4 are moved through the pipe 9 upon erection or retraction of the mast 2, as well as the dynamic friction between the tubular pipe 9 and the first leg attachment collar 5 during production, and the dynamic friction between the tubular pipe 9 and the leg guide collar 6 when folding or unfolding the base 1, thereby reducing the effort and the wear during the set-up and retraction of the base 1 for the mast 2, as well as the time required to set-up or retract the mast 2. The use of these materials permits reducing the weight of the guide shaft 3 and the base 1, and a strong and stable base 1, which can easily be produced, is provided. Further, by providing the entire tubular pipe 9 of a low friction material, the use of friction limiting strips or wheels inside the guide shaft 3 can be dispensed with, saving cost and labor during manufacturing, and obstruction of the mast elements 4 by loosening strips or broken wheels is prevented, and wearing of the friction reducing material occurs in a more uniform way over the entire inner surface of the tubular pipe 9.

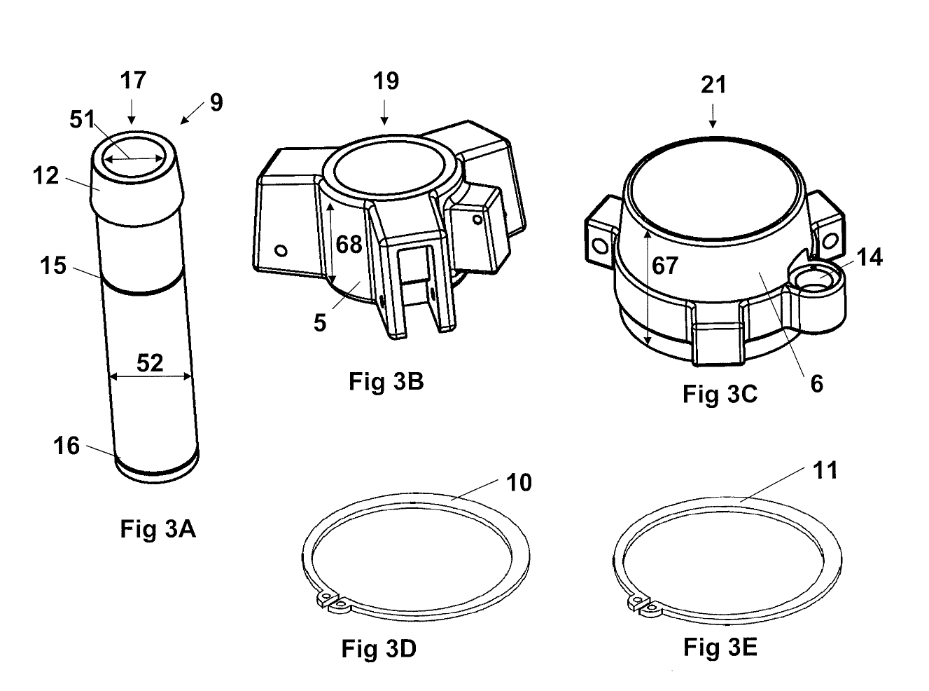

The guide shaft 3 of the base 1 of FIG. 1A comprises a tubular hollow pipe 9 with an opening 17 extending from the top to the bottom of the tubular pipe for guiding the displacement of the tubular mast elements 4 during erection or retraction of the mast 2, and for holding at least one tubular mast element 4 when the mast is erected. The tubular pipe 9 of the base 1 preferably has a circular cross section of a substantially constant outer diameter 52 (FIG. 3A) over the lower part of the tubular pipe 9, to allow mounting of the first leg attachment collar 5 and the leg guide collar 6 during manufacturing of the guide shaft 3. With a “substantially constant outer diameter” is meant that small deviations due to production tolerances are permitted, but it also means that one or more narrow grooves are permitted.

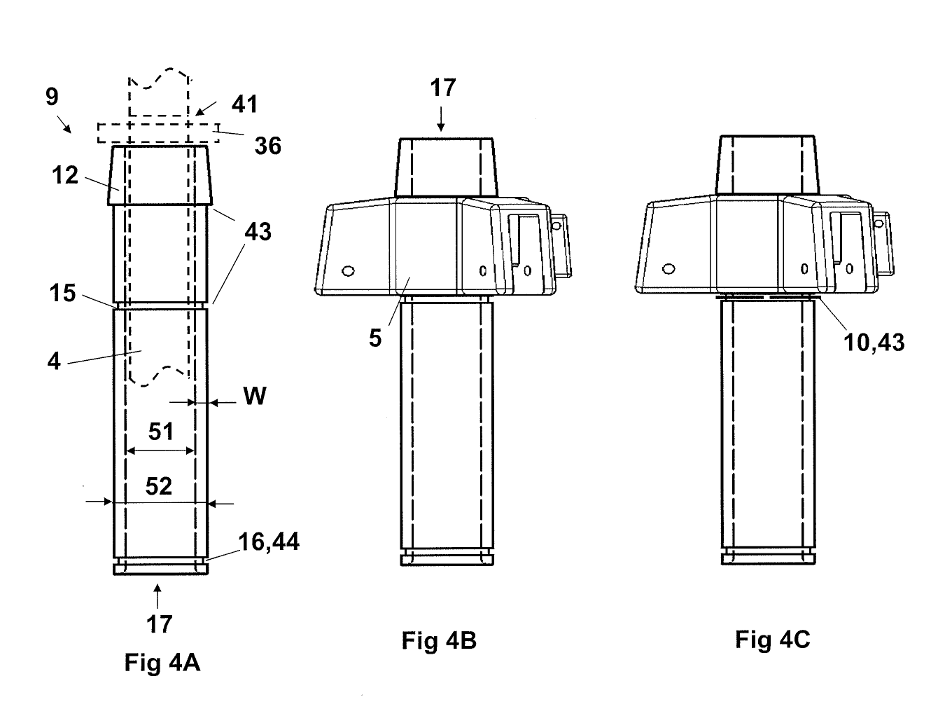

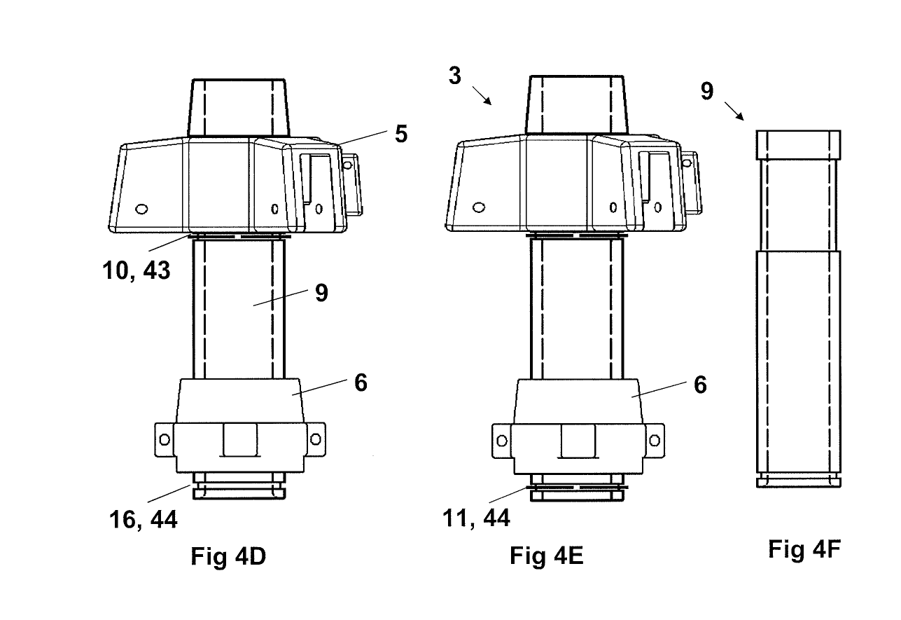

The tubular pipe 9 has an opening 17 of a constant inner diameter 51 (FIG. 3A) to allow insertion and displacement of the tubular mast elements 4 throughout the pipe during erection or retraction of the mast 2. As shown in FIG. 4A, the tubular pipe 9 has a collar 12 upon which a mast suspending pin 36, which can be inserted in transverse direction of the mast, can rest when erecting or retracting a mast, for suspending part of the mast. The tubular pipe 9 also has position limiting means 43, 44 to permit fixing the position of the first leg attachment collar 5 on the tubular pipe 9, and to restrict movement of the leg guide collar 6 on the tubular pipe 9, for example the lower part of the tubular pipe collar 12 and a first and second groove 15, 16 on the outside surface of the tubular pipe 9, wherein a circlips can be mounted. Other shapes of the tubular pipe 9 than the one shown in FIG. 4A are also possible, for example the shape of the tubular pipe collar 12 can be cylindrical instead of conical. The tubular pipe 9 is preferably made of POM (Polyoxymethyleen), which is a strong and lightweight material, having a mass density of only 1.4 kg/dm³. This material is preferred as it shows low friction with the tubular mast elements 4, which are typically made of aluminum, preferably anodized aluminum, or of composite materials, and which are inserted in the cylindrical opening 17 of the guide shaft 3 when the mast 2 is erected or retracted. The inventor thus came to the idea to use a tubular pipe 9 entirely made of a strong and low friction material as the core of the guide shaft 3. Other materials with low friction properties can also be used for the tubular pipe 9, for example: PTFE (Teflon), polyurethane (PUR), polyimide particularly nylon 6, nylon 66, nylon 11, nylon 12 or nylon 46 or copolymers thereof, polyester, in particular polyethylene-terephtalate (PET), polytrimethyleneterephtalate (PTT), polybutyleneterephtalate (PBT), high molecular weight polyethylene, ultra high molecular weight polyetheylene, polyetherketones, particularly polyethyletherketone (PEEK), PEEKK, polyethersulfones, polysylfones, polyvinylidenefluoride (PVDF), a polyester copolymer or mixtures of two or more of these polymers. A further advantage of these plastic materials is that they are electrically isolating, thereby electrically isolating the mast 2 and the equipment 8 mounted thereto from the legs 7 of the base 1, which is safer for the personnel erecting or retracting the mast 2, especially in case of a lightning strike. The base 1 of FIG. 1A also works when the tubular pipe 9 is made of another material such as aluminum or an aluminum alloy, but the weight of such a base 1 using aluminum would be higher than a base 1 using POM, and there would be more friction with the tubular elements 4 of the antenna mast. Especially metal to metal contact should be avoided, as it causes scratches and wear to both surfaces of the metals in contact, which would obstruct smooth insertion and lifting or lowering of the mast elements 4 during erection or retraction of the mast, or would obstruct smooth rotation of the mast 2 when directing the equipment 8 mounted to the mast after erection. Especially for a mast 2 with heavy equipment 8 on top, e.g. an antenna or lighting of 25 kg or more, smooth movement and rotation of the tubular elements 4 in the tubular pipe 9 is important, and shocky movements should be avoided. Preferably the tubular pipe 9 has a shape with a radial symmetry, preferably with an inner and outer circular cross section, as such a shape can easily be produced or machined on a lathe, but the invention also works with other inner or outer shapes, e.g. square, hexagonal, octagonal.

In an alternative embodiment the collar 12 is made as a separate part, which is mounted upon the tubular pipe 9 using conventional fixation means, such as glue, screw-thread, etc. This approach allows a different material to be chosen for the collar 12 and for the tubular pipe 9, the latter being preferably made of POM. The collar 12 could e.g. be made of a material with a large load bearing capacity, for example a material with a hard surface that has only a limited risk to deformations when the mast suspending pin 36 (FIG. 4A) is resting upon it to support the full weight of the mast, e.g. steel or aluminum.

As shown in FIG. 1A and 1B, near the top of the tubular pipe 9 a first leg attachment collar 5 is mounted. FIG. 3B shows the first leg attachment collar 5 in more detail. It has a cylindrical opening 19 with an inner diameter larger than the outer diameter 52 of a lower part of the tubular pipe 9 to allow shifting the first leg attachment collar over the tubular pipe 9 during assembly, and a plurality of connection positions, e.g. three or more, whereto the legs 7 can be hingedly connected at a first connection position on the legs 37 using conventional connection means. The first leg attachment collar 5 can be made of the same material as the tubular pipe 9, or of a different material. The first leg attachment collar 5 is typically made of cast or machined aluminum or an aluminum alloy, as this is a strong and lightweight material that can easily be produced in the desired shape. The first leg attachment collar 5 needs to be strong to support the full weight of the mast during erection or retraction of the mast, and to transfer that weight to the legs 7 via the first connection position on the legs 37. Aluminum has a low mass density of approximately 2.7 kg/dm³, and the shape of this part is suited to be manufactured by casting or machining, which is an easy and economic process step. The height of the first leg attachment collar 68 is chosen such that tilting of the first leg attachment collar 5 is counteracted, e.g. when mounting it on the tubular pipe 9. In the preferred embodiment the height 68 is chosen approximately equal to the inner diameter of the first leg attachment collar opening 19, but other values are also possible. The person skilled in the art can use different sizes, shapes, materials and processes known in the art for making the first leg attachment collar 5.

In an alternative embodiment of the base 1 of FIG. 1A, the tubular pipe 9 and the first leg attachment collar 5 can be constructed as a single part, e.g. by injection molding, moulding or casting or extruding, and could be made of aluminum, an aluminum alloy or a plastic material as listed above.

As shown in FIG. 1A and 1B, the legs 7 can be connected to the base 1 using conventional connection means such as screws and bolts, or hinge pins 59 with a groove and circlipses mounted on both sides (as shown in FIG. 10), but any other method known to the person skilled in the art can also be used. FIG. 1A shows a base 1 with three legs 7, but four or more legs are also possible.

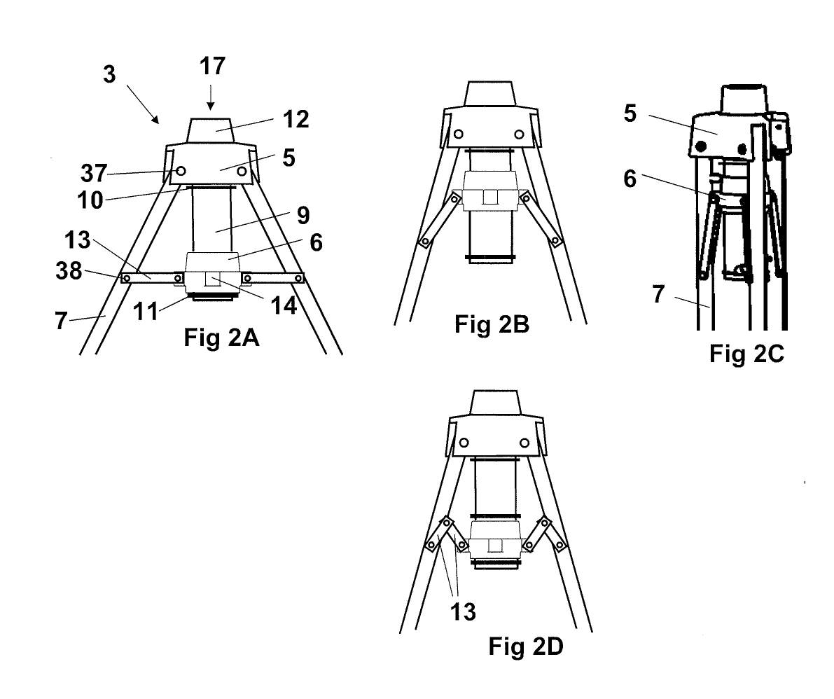

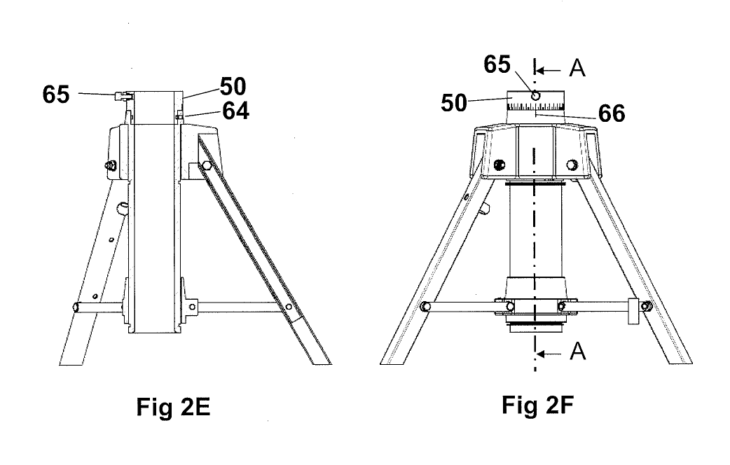

The tubular pipe 9 extends from the first leg attachment collar 5 to a position below the first leg attachment collar where preferably a leg guide collar 6 is mounted around the tubular pipe to enable a second connection between the legs 7 and the tubular pipe 9. FIG. 3C shows a preferred embodiment of the leg guide collar 6. The wall thickness of the leg guide collar 6 can be the same as that of the first leg attachment collar 5, or can be larger or smaller. Typically however the leg guide collar 6 can have a thinner wall thickness than that of the first leg attachment collar 5, as the leg guide collar 6 does not have to bear the full weight of the antenna mast 2, but only needs to hold the position of the legs 7, thus material cost and weight can be saved. The leg guide collar 6 is preferably made of machined aluminum or cast aluminum or another aluminum alloy that can be easily machined. By providing the leg guide collar 6 around the tubular pipe 9 instead of using a localized connection, the connection force can be divided over a large contact area. Preferably but not necessarily, the leg guide collar 6 is displaceable over the tubular pipe 9 in height direction of the mast 2 between an upper position limited by the position of the first leg attachment collar 5 and a lower position limited by second position limiting means such as e.g. a groove 16 and a circlips 11 mounted to a lower part of the tubular pipe 9. By shifting the leg guide collar 6 over the tubular pipe 9, the legs 7 are moved simultaneously between an extended position, as shown in FIG. 2A, and a retracted position, as shown in FIG. 2C. It is clear that the open or extended position provides a stable base 1 for supporting a mast 2, while the closed or retracted position is used for easy transportation. This is especially useful for a temporary mast that needs to be set-up and retracted frequently. FIG. 2B shows an intermediate position, whereby the legs 7 are halfway between the extended and the retracted position. In an alternative embodiment the leg guide collar 6 is rigidly mounted to the tubular pipe 9. In this case the connection between the legs 7 and the leg guide collar 6 preferably allows the distance between them to be adjustable, e.g. by using for each leg two guide spacers 13 hingedly connected in series, as shown in FIG. 2D. This enables the base 1 to be folded for transportation or unfolded for supporting a mast 2. In this case the legs 7 do not open or close simultaneously. The height of the leg guide collar 67 is preferably chosen such that the leg guide collar 6 cannot tilt, which would obstruct easy sliding over the tubular pipe 9. This height 67 can e.g. be chosen approximately equal to the inner diameter of the leg guide collar opening 21, but other values are also possible. The person skilled in the art can use different sizes, shapes, materials and processes known in the art. Preferably the leg guide collar 6 has a position for mounting an optional bubble level 14, to facilitate rapid installation of the base 1 in a vertical position. In an alternative embodiment of the guide shaft 3 the bubble level 14 could be mounted to the first leg attachment collar 5, or both. Instead of a single circular bubble level also two oblong bubble levels can be used.

At a second connection position on the legs 38, the legs 7 are connected to a lower part of the tubular pipe 9 using second connection means 39, which may be a direct connection or an indirect connection. In FIG. 1A showing the preferred embodiment of the base 1, the legs 7 are connected to the leg guide collar 6 using guide spacers 13 and conventional connection means. The guide spacers 13 are intended to keep the legs 7 of the base 1, when unfolded, at a predefined position from the tubular pipe to provide a stable base 1. They are typically made of steel or stainless steel, but they can also be made of a lightweight metal such as aluminum or an aluminum alloy, or other suitable materials known to the person skilled in the art.

The leg guide collar 6 is a preferred way of connecting the lower part of the tubular pipe 9 to the legs 7, but other ways are also possible, for example by mounting the guide spacers 13 to a protrusion (not shown) on the outer wall of the tubular pipe 9, or by using a tubular insert in the bottom of the tubular pipe 9, which insert can then be connected to the legs 7.

In a preferred embodiment the tubular pipe 9 has a tubular pipe collar 12 extending above the first leg attachment collar 5, to rest upon the first leg attachment collar 5 for transfer of the weight of the mast 2 during erection or retraction, and for temporarily supporting the mast suspending pin 36 (see FIG. 4A) which can be inserted in a mast element 4 during erection or retraction of the mast 2, as will be explained further. Other shapes of the tubular pipe collar 12 than the one shown in FIG. 1B can also be used.

Optionally but not mandatory the first leg attachment collar 5 and the leg guide collar 6 are mounted in a rotatable manner around the tubular pipe 9. In this case two levels of rotation can be provided to the mast 2 during set-up, as the tubular mast elements 4 can rotate inside the tubular pipe 9, and the tubular pipe 9 can rotate inside the first leg attachment collar 5 and inside the leg guide collar 6. This might be beneficial in environments where sand or dirt could hinder the rotation of the mast 2. This is particularly advantageous when directional antennas are mounted on the mast 2, as in this case the antenna should be correctly directed to within approximately one degree angle, thus smooth rotation of the mast inside the guide shaft 3 is desired. It will be described further, when discussing the field base 58, how rotation of the mast 2 can be prevented. In an alternative embodiment of the base 1 the first leg attachment collar 5 and the leg guide collar 6 can be mounted to the tubular pipe 9 in a non-rotatable way, using e.g. glue or screws, or grooves and a local insert, or any other technique known to the person skilled in the art to block such rotation.

Optionally but not mandatory the base 1 has a graduated collar 50 which is mounted to the tubular pipe collar 12, and can be used for easy orientation and correct positioning of the mast 2, and optionally the collar 12 of the tubular pipe 9 has an indicator 66 that can be aligned with one of the graduations on the graduated collar 50. The graduated collar 50 shown in FIGS. 2E and 2F has the same inner diameter as the inner diameter of the tubular pipe 9, and has provisions with a groove and a first screw 64 to prevent the graduated collar 50 from being lifted along with the tubular mast elements 4 when erecting the mast 2. When the mast 2 is fully erected the graduated collar 50 can be mounted to a tubular mast element 4 by means of a second screw 65, so that the graduated collar 50 rotates along with the mast. Other shapes of the graduated collar, and other ways of mounting them known to the person skilled in the art, can also be used.

Choosing lightweight materials for the base 1 is especially advantageous for transportable masts 2, which need to be erected and retracted quite frequently.

FIGS. 4A-4E describe how the parts of FIGS. 3A-3E are mounted to form the preferred embodiment of the guide shaft 3. Starting with a tubular pipe 9 (FIG. 4A), a first leg attachment collar 5 is shifted over the tubular pipe 9 until it reaches the tubular pipe collar 12 (FIG. 4B), where the outside diameter of the tubular pipe collar 12 is larger than the inner diameter of the first leg attachment collar opening 19. The tubular pipe collar 12 serves as the upper part of the first position limiting means 43. Next, a first circlips 10 (FIG. 3D) is mounted in the first groove 15 of the tubular pipe (FIG. 4C) to limit the lower position of the first leg attachment collar 5 on the tubular pipe 9, thus the height position of the first leg attachment collar 5 on the tubular pipe is fixed. In a next step the leg guide collar 6 is shifted over the tubular pipe 9 (FIG. 4D), and a second circlips 11 (FIG. 3E) is mounted in the second groove 16 of the tubular pipe 9 (FIG. 4E) to limit the lower position of the leg guide collar 6 on the tubular pipe 9. The second groove 16 and the second circlips 11 thereby form the second position limiting means 44. The resulting structure (FIG. 4E) is a preferred embodiment of the guide shaft 3 of the base 1 of FIG. 1A. The leg guide collar 6 of the preferred embodiment of the guide shaft 3 can thus be shifted between the location of the first groove 15 and the second groove 16 on the tubular pipe. To make the base 1, legs 7 and second connection means, e.g. guide spacers 13, are attached to the guide shaft 3 using conventional attachment means such as screws and bolts, or hinge pins 59 with grooves and circlipses (FIG. 10), but any other method known to the person skilled in the art can also be used.

The use of grooves 15, 16 in the tubular pipe 9 and circlipses 10, 11 mounted in the grooves is a very easy, fast and elegant way of limiting the positions, at only a minimal cost and labor during manufacturing. As there is never any substantial force exerted upon the circlipses 10, 11, the grooves 15 , 16 can be made shallow, and the thickness W of the wall of the tubular pipe 9 can thus be substantially constant below the tubular pipe collar 12, as shown in FIG. 4A. When using POM as a material for the tubular pipe 9, the inventor has discovered that a wall thickness W of 5-15 mm, preferably 7-13 mm, more preferably 9-11 mm gives an optimal compromise in terms of weight and strength.

By choosing aluminum or an aluminum alloy or one of the plastic materials listed above for the parts of the guide shaft 3, it should be clear from the FIGS. 3A-3E and from the description that the parts of the guide shaft 3 of the present invention are lightweight and easy to manufacture. And it should also be clear from the FIGS. 4A-4E and from the description that the guide shaft 3 and the base 1 of the mast assembly of the present invention can be easily assembled, thereby resulting in a lightweight, rigid and stable base 1 for a mast 2, showing low friction with the tubular mast elements 4, which are typically made of anodized aluminum or a composite material, e.g. a fiber reinforced plastic material.

In an alternative embodiment of the base 1 according to the present invention, the tubular pipe 9 and the first leg attachment collar 5 could be made as a single piece, or not. When using the same material for the tubular pipe 9 and for the leg guide collar 6, these parts can be made as a single piece, or not. When the first, second and third material are the same, the tubular pipe 9 and the first leg attachment collar 5 and the leg guide collar 6 can be made as a single piece, or not.

In an alternative embodiment of the base 1 according to the mast assembly of the present invention, the tubular pipe 9 and the first leg attachment collar 5 and the leg guide collar 6 can be moulded or casted or extruded as a single part, resulting in a structure looking like the one shown in FIG. 4E without the grooves 15, 16 and circlipses 10, 11. This structure would not have the capability to move the leg guide collar 6 over the tubular pipe 9.

However a base 1 using the guide shaft 3 of this alternative embodiment could also be folded and transported, e.g. after disconnecting the guide spacers 13 from the legs 7, or by using a series of guide spacers 13 as shown in FIG. 2D.

FIG. 4F shows an alternative embodiment of the tubular pipe 9, where the outer diameter of the tubular pipe 9 is smaller at the position of the first leg attachment collar 5. In this case the first leg attachment collar 5 could be mounted by assembling two or more parts around the tubular pipe 9. In this way the first circlips 10 would not be required to limit the position of the first leg attachment collar 5.

Above a preferred embodiment of the base 1 of the mast assembly 47 according to the present invention was described, but the invention will also work with another base.

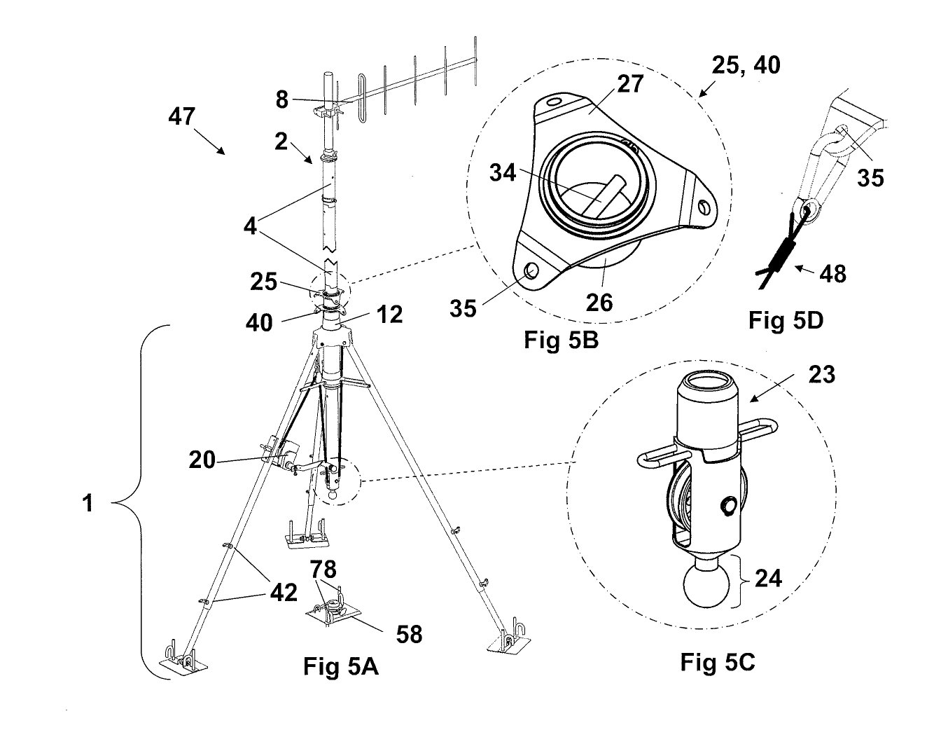

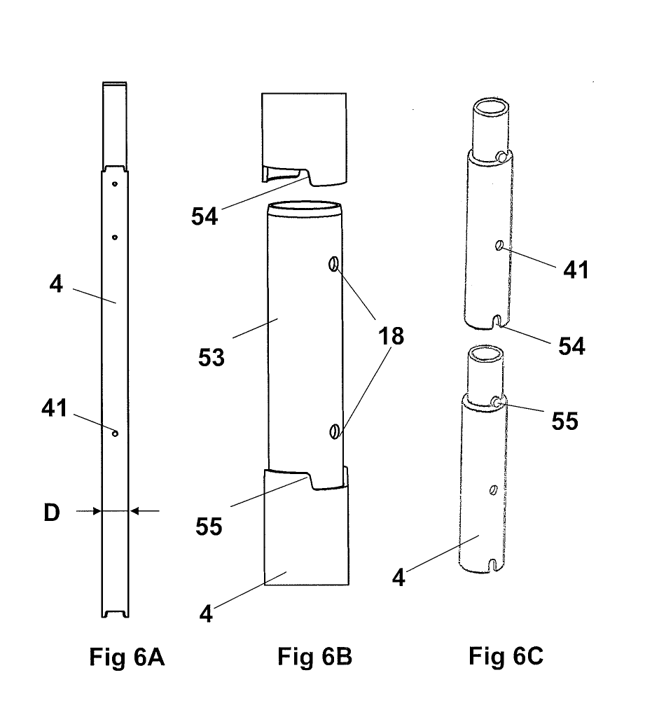

The principle of setting up a mast 2 using the preferred embodiment of the base 1 will be explained next with reference to FIG. 5A. Starting from a folded base 1 as shown in FIG. 2C, first the legs 7 are opened, by shifting the leg guide collar 6 away from the first leg attachment collar 5 to obtain a stable base 1 as shown in FIG. 2A. Then the lengths of the legs 7 are adjusted to place the tubular guide shaft 3 at a height of e.g. 1.40 m above the ground to enable insertion of mast elements from a position below the guide shaft. The legs 7 of the base 1 are preferably made telescopic in conventional ways. In the example of FIG. 5A the length of the legs 7 can be adjusted using two leg adjustment screws 42 per leg, but any other means known to the person skilled in the art can also be used. Then the base 1 needs to be positioned vertically, which is typically done using the bubble-level 14 mounted to the leg guide collar 6 as an aid. The mast needs to be positioned as vertical as possible to prevent bending of the tubular mast elements 4, or falling over of the mast 2. Further a winch 20 and a lifting block assembly 23 can be attached to the base 1. Using the winch, the position of the lifting block assembly 23 is lowered to allow placement of a first tubular mast element 4 upon it. Then the first tubular mast element 4 is lifted using the winch and guided inside the upright opening 17 of the guide shaft 3 to a position extending above the tubular pipe collar 12. Next, one or more guy collar assemblies 25, 40 are shifted over the first tubular mast element 4 from above. In a next step a device 8, such as an antenna or camera or microphone or lighting etc. can be mounted to the first tubular mast element, using the device mounting holes 18 (FIG. 6B) and conventional attachment means e.g. screws. Optionally the legs 7 have provisions for mounting steps (not shown) thereto, which steps can e.g. be used to stand upon when mounting the equipment 8 to the mast 2. Then the first mast element 4 is further lifted until a mast suspending pin 36 can be inserted in a hole 41 (FIG. 4A, FIG. 6A) of the first tubular mast element 4, above the tubular pipe collar 12, where after the lifting block assembly 23 is lowered again so that the mast suspending pin 36 rests upon the tubular pipe collar 12, holding the first mast element 4 in a suspending position with respect to the guide shaft 3, as shown in FIG. 4A in dotted line. The lifting block assembly 23 can then be lowered further down, to enable placement of a second tubular mast element 4 upon it. Using the winch 20 the second tubular mast element 4 can then be lifted until its upper part approaches the lower part of the first tubular mast element 4 suspended in the base 1. The second tubular mast element 4 will then be aligned and rotated so that the upper part of the second tubular mast element 4 engages with the lower part of the first tubular mast element 4. Using the winch 20, both tubular mast elements 4 and the mounted equipment 8 are then lifted, the mast suspending pin 36 is removed, and the first guy collar assembly 25 is mounted to the upper tubular mast element 4 by inserting the guy collar assembly pin 34 in the hole 41 (FIG. 6A) of the upper tubular mast element 4. Mounting to the upper mast element 4 is preferred, as this provides the highest stability of the mast 2. Then the partly mounted mast 2 is lifted further until the mast suspending pin 36 can be inserted in hole 41 of the second tubular mast element 4 above the tubular pipe 9, where after the lifting block assembly 23 is lowered again, and so on. When all tubular mast elements 4 are mounted, the position of the entire mast 2 including the lifting block assembly 23 is lowered so that a bottom element 24 (FIG. 5C) of the lifting block assembly 23 can be placed in a field base 58, which is mounted on the ground under the base 1 by means of spikes 78, so that the weight of the mast 2 no longer needs to be supported by the base 1, but is transferred directly to the field base 58.

It is an advantage of the guide shaft 3 described above that it can be made of two or more components, preferably three (the tubular pipe 9, the first leg attachment collar 5, the leg guide collar 6), which are and remain well positioned with respect to each other during erection or retraction of a mast, and which provide an optimal guidance for the displacement of the tubular mast elements during erection or retraction of the mast 2.

FIG. 5A shows an antenna as the equipment 8 to be positioned at height, but other equipment such as e.g. a camera, a microphone or lighting can also be used.

FIG. 5A shows a mast 2 at an early stage of erection, with two guy collar assemblies 25, 40 shifted over the tubular mast elements 4 and temporarily resting on the tubular pipe collar 12, to enable mounting of the guy collar assemblies 25, 40 to specific tubular mast elements 4 during further erection of the mast 2, but more than two can also be used, e.g. for a large mast. By connecting the guy collar assemblies 25, 40 to specific tubular mast elements 4 during erection, they can be located at predefined positions T, M (FIG. 7A) after the mast 2 is fully erected. The guy collar assemblies 25, 40 allow stabilizing the mast 2 during erection, during retraction, and during normal use of the mast, i.e. when the mast is fully erected, by providing means for connecting at least three guy control wires 71 which can be kept under tension in at least three different directions, thereby keeping the mast 2 in a stable position.

FIG. 5B shows the preferred embodiment of the guy collar assembly 25, 40. It comprises a tubular element 26, whereto a blade 27 is preferably rotatably mounted. The blade 27 typically comprises at least three guy wire mounting holes 35 preferably equally distributed around the blade 27, but other positions are also possible. Referring to FIG. 7A, the wires, cables or ropes attached to the upper guy collar assembly 25 are called guy control wires 71, whereas the wires, cables or ropes attached to the other guy collar assembly (or assemblies) 40 are called guy wires 72. At least three guy control wires 71 are attached to the upper guy collar assembly 25 for keeping the mast 2 upright, each guy control wire preferably being mounted to one mounting hole 35. The first ends of the guy control wires 48 (FIG. 5D) are attached to the upper guy collar assembly 25, which is typically mounted to the upper tubular mast element 4 corresponding to a position T on the mast (FIG. 7A). The guy collar assembly 25 is preferably mounted to the mast using a removable connection, e.g. a removable pin 34 (FIG. 5B) passing through the guy collar assembly 25 and through a hole 41 of the tubular mast element 4, thereby fixing the position of the guy collar assembly 25 in height with respect to the mast 2. When using a mast 2 with two guy collar assemblies 25, 40, the second guy collar assembly 40 is typically mounted to the tubular mast element 4 corresponding to a position M at about half the height of the mast 2 (FIG. 7A). When three guy collar assemblies 25, 40 are mounted to the mast, they are preferably placed near the top, near ⅔ of the height, and near ⅓ of the height of mast, etc. In an alternative embodiment of the present invention the guy collar assemblies 25, 40 can have four or more guy wire mounting holes 35, for attachment of four or more guy (control) wires 71, 72.

In the prior art, the second ends of the guy control wires 71 are typically routed to three different positions X, Y, Z near the ground, located at a predetermined distance R from the base 1, thus lying on an imaginary circle with the base 1 standing in the centre, the three positions X, Y, Z lying preferably 120 degrees apart on the imaginary circle. In the prior art these guy control wires 71 are only fastened to the positions near the ground after the mast 2 is fully erected, not during erection or retraction of the mast. Alternatively they are kept under tension by three or more persons standing at a distance R from the base 1 during erection of the mast, and they are fastened to a position near the ground after the mast is fully erected. In other words, in the prior art the guy control wires 71 are typically routed from point T to X, from T to Y and from T to Z, and they are fastened at the points X, Y, Z to a position near the ground after the mast is fully erected. A disadvantage of the first mentioned prior art method is that the mast is not stabilized during erection or retraction, making it impossible or unsafe to set-up a mast under windy conditions. A disadvantage of the second mentioned method used in the prior art is that it requires more people during the set-up of the mast, and that it is very difficult to keep the mast stabilized when the three or more guy control wires are held by three or more different people, without causing oscillations of the mast 2. These disadvantages are especially important in military applications, where the minimal amounts of personnel, optimal safety to the equipment 8 on and next to the mast 2, as well as a fast set-up time under all weather conditions are of main importance.

The present invention provides an improved method for keeping the mast 2 upright, during normal use of the mast, as well as during its erection or retraction, even under windy conditions, with a minimal amount of people, using mechanical means that can be hand carried, and without requiring electrical power or batteries. This is especially important for military applications. Thereto the present invention uses a method of routing the guy control wires 71 to a single point P, where a single person can keep the three or more guy control wires 71 under tension, by using a guy control assembly 28. The guy control assembly is also an object of the present invention.

In order to be able to apply this improved method for stabilizing the mast 2 during erection or retraction, the mast assembly 47 comprises at least three guy control wires 71, the first ends 48 of the guy control wires 71 being connected to the mast 2 at an upper position T on the mast 2, the second ends 49 of the guy control wires 71 being routed to at least three different positions X, Y, Z near the ground at a distance from the base 1, to which positions they can be fastened, which is typically done after the mast 2 is fully erected, or from which positions they can be routed further to a single position P to permit keeping the guy control wires 71 under tension by a single person during erection or retraction of the mast.

Preferably the three different positions X, Y, Z near the ground are located on an imaginary circle of radius R, lying preferably 120 degrees apart, where the base 1 is standing in the centre, and the radius R is chosen such that the angle β between the ground surface and the guy control wire 71 is between 45 and 60 degrees, but other angles are also possible. Using these positions provides for a uniform tension in the guy control wires 71 and optimal correction capabilities for the mast 2, while the area occupied by the mast assembly 47 is limited.

As shown in FIG. 7B, preferably the locations X, Y, Z near the ground each comprise a pulley block 56 to allow further routing of the guy control wires 71 to a point P where a single person can keep the guy control wires 71 under tension during erection or retraction of the mast 2, and a guy tensioner 32 to allow fastening the guy control wires 71 to the position near the ground after erection of the mast 2. Instead of continuously adapting the length or position of each of the guy control wires 71 during the erection or retraction of the mast 2, the person at point P can move between a first point P1 and a second point Pn, thereby adapting the length of all guy control wires 71 simultaneously, while keeping them under tension. The point P1 preferably being located on an imaginary line passing through the center of the base 1, at a predetermined distance from the center of the base of typically 1.3-1.5 times the height of the mast, and the point Pn being located on the same line at a distance of typically 0.8-1.0 times the height of the mast, the exact distance depending on the angle β between the ground surface and the guy control wires 71.

Preferably this method is performed by routing the second ends 49 of the guy control wires 71 to a guy control assembly 28 located at location P, the guy control assembly 28 having means for keeping at least three guy control wires 71 under tension. The guy control assembly 28 is a tool that can be hand held, and allows to keep all guy control wires 71 under tension simultaneously. It also allows the tension of one or more guy control wires 71 to be adapted while keeping the other guy control wires under tension.

Preferably the guy control assembly 28 has at least three wire holding means 31 for holding the guy control wires 71 under tension, and has at least two handles 75, 76 for holding the guy control assembly 28, the handles being located at opposite sides of the part guiding the wires.

Preferably the guy control assembly 28 has three handles 75, 76, 77 by which it can be held, one on the left, one on the right, and one below.

Preferably the wire holding means 31 are rope cleats.

As shown in FIGS. 7A-7D, the three guy control wires 71 of the mast assembly of the present invention have an increased length, typically almost double the length typically used in the prior art, and they are routed from T over X to Y to P₁, from T over Z to Y to P₁, and from T to Y to P₁, the three guy control wires 71 thus coming together at a single point Y, from where they are routed to a point P₁ where a single person holding the guy control assembly 28 can keep the three guy control wires 71 under tension simultaneously, especially during erection or retraction of the mast 2. Typically the person holding the guy control assembly 28 starts at a position P₁ at the start of the mast erection and gradually approaches to a point Pₙ while the mast elements 4 are being lifted, in order to keep the guy control wires 71 under tension. When the mast 2 is completely erected, the guy control wires 71 are fastened to the support surface, e.g. the ground, by means of fastening means. Preferably the guy control wires 71 are fastened to pickets 30 at location X and Z and to a control picket 29 at location Y, by means of e.g. guy tensioners 32, pulley blocks 56 and carbine hooks 33. After all the guy control wires 71 are fastened to the pickets 30 and to the control picket 29, the other guy wires 72, which are fastened at one end to the guy collar assembly 40 which is mounted to the mast, are also tightened and fastened to the pickets 30 or to the control picket 29. Thus after the mast 2 is fully erected, each guy control wire 71 and each guy wire 72 is fastened at one end to the mast, preferably to a guy collar assembly 25, 40, and to a position on the control surface, preferably a picket or control picket, at the other end, thereby keeping the mast in a fixed position.

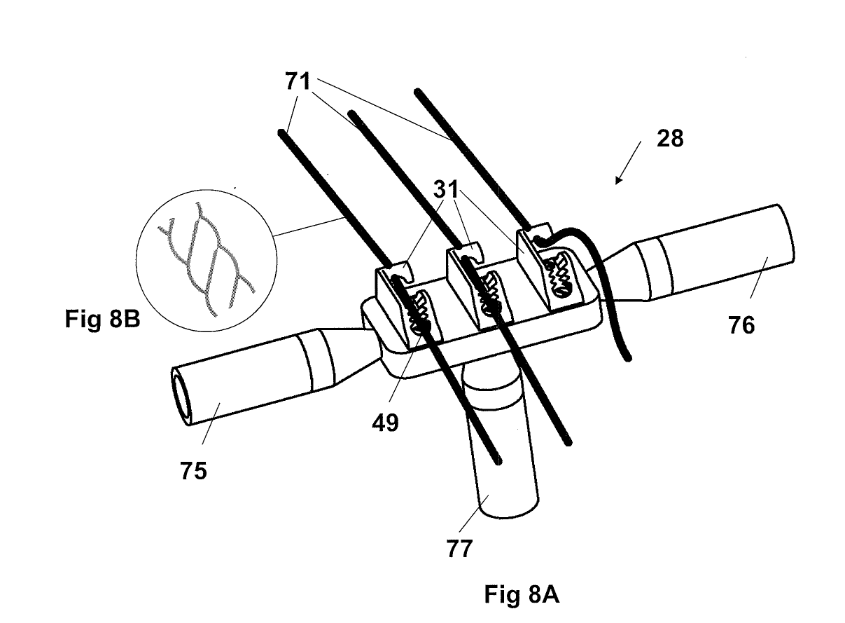

FIG. 8A shows a preferred embodiment of the guy control assembly 28 of the present invention in more detail. It comprises three handles, a left handle 75, a right handle 76 and a lower handle 77, and three rope cleats 31 for attaching the second ends 49 of the guy control wires 71 to the guy control assembly 28. The three guy control wires 71 are placed on the rope cleats 31 and are kept under tension such that the mast 2 is standing upright. The person holding the guy control assembly 28 typically uses both hands holding the left and right handle 75, 76 to have good control over the guy control assembly 28. By moving towards or away from the base 1, the guy control wires 71 are kept under tension, and the mast 2 is kept upright. When a single guy control wire 71 needs to be adjusted, a right handed person typically releases his left hand to grasp the lower handle 77, and then releases the right hand to correct the position of the guy control wire 71 while firmly holding the guy control assembly 28 in his left hand and keeping the other guy control wires 71 under tension. After correction of the specific guy control wire 71 he takes again the right handle 76 in the right hand, and finally also the left handle 75 in the left hand.

Alternatively first the right hand can be moved to the bottom handle, and then the left hand released to correct the position of a wire, etc.

When retracting a mast 2, a similar procedure as described above for erecting a mast 2 can be followed, but the person holding the guy control assembly 28 would start from a point Pₙ near the point Y on the imaginary circle, and gradually move away from the base 1 towards a point P₁, while keeping the guy control wires 71 under tension.

An alternative embodiment of the guy control assembly 28 may comprise one or two handles, and/or four or more rope cleats 31. Other shapes of the guy control assembly 28, or of the handles 75-77, or of the rope cleats 31 than shown in FIG. 8A are possible.

FIG. 8B shows an example of a guy control wire 71, which is preferably made of Terylene™, polyester or Kevlar®, but other materials are also possible. The guy control wires 71 should be strong enough to support the tension exerted upon it, especially under windy conditions.

The method for keeping the mast 2 upright as described above, has no direct relation with the base 1, since the guy control wires 71 of the mast assembly of the present invention are routed to pickets 30, 29 and not to the legs 7 of the base 1, in contrast to the system shown in FIG. 1 of U.S. Pat. No. 4,212,015. It is therefore clear to the person skilled in the art that the method of the present invention will also work for a mast assembly 47 using another base 1 than the one shown in FIG. 1A, in particular a base 1 without a tubular pipe 9.

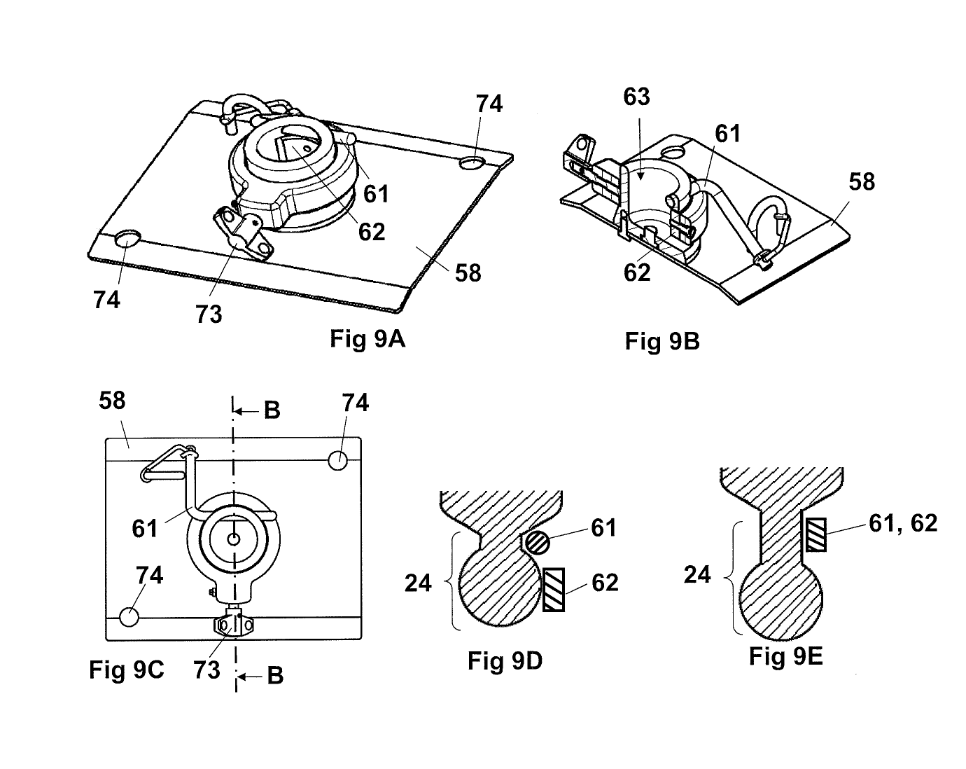

The present invention also provides an improved field base 58 for supporting the mast during its normal use, i.e. when fully erected. The field base 58 is provided for positioning on a supporting surface, e.g. on the ground, at a position which corresponds to the position of the mast 2 to permit bearing of at least part of the weight of the mast 2 after erection, whereby the field base 58 comprises first fixation means 61 for fixing the mast 2 to a support plane and preventing displacement in height direction of the mast assembly 47, and second fixation means 62 for preventing rotation of the mast 2 around its axial axis. FIGS. 9A-9C show a preferred embodiment of the field base 58 according to the present invention. The field base 58 has an opening 63 extending in upright direction of the mast for receiving a bottom element 24 which is preferably mounted to a lower part of the mast 2 in a non-rotatable way. The bottom element 24 may have constant dimensions in radial direction, but preferably has a smaller outer dimension at a higher part than at a lower part. The field base 58 has provisions for receiving first fixation means 61, e.g. a pin, which can be inserted in a second opening of the field base 58 to decrease the size of the upright opening 63, thereby preventing the mast 2 to move in an upward direction. The field base 58 further comprises a fixation component 62 mounted to the field base 58. The fixation component 62 can be moved towards (or away from) the center of the upright opening 63 in radial direction for tightening (or loosening) the bottom element 24 to (or from) the field base, thereby preventing (or allowing) rotation of the mast 2.

FIG. 5A shows a field base 58 mounted to the ground in a position corresponding to and below the mast 2. The field base 58 is typically mounted to the ground by inserting spikes 78 in the ground through the mounting holes 74 of the field base 58, so that the field base 58 cannot rotate or be lifted with respect to the ground. Positioning the mast 2 on the field base 58 is the last step during erection of the mast 2. After all tubular elements 4 have been added to the mast 2 as described above, the mast 2 with the lifting block assembly 23 mounted underneath, is lowered towards the support surface, usually the ground, so that the lower part of the lifting block assembly 24, in this case a sphere with a small cylindrical shape on top of it, is placed inside the upright opening 63 of the field base 58. Then a height fixation pin 61 of the field base is inserted in a second opening of the field base 58 to decrease the inner diameter of the upright opening 63. The pin 61 prevents displacement of the bottom element 24 in height direction of the mast 2, which could occur under windy conditions, whereby the mast 2 could be lifted out of the field base 58, and be positioned next to the field base 58, thereby loosing its vertical position and/or its orientation. Insertion or removal of the height fixation pin 61 is a very fast and simple step for securing or releasing the height position of the mast 2.

FIG. 9A and 9C show a wing screw 73 to enable tightening of a fixation component 62 against the bottom element 24 of the mast 2, thereby preventing rotation of the mast 2. FIG. 9D shows the working principle using a separate first and second fixation means 61, 62. FIG. 9E shows the working principle of an alternative embodiment of the field base 58 according to the present invention, using a single fixation means 61, 62 to prevent both lifting and rotation of the mast 2 with respect to the field base 58. An advantage of using a spherical shape as the bottom element 24 of the lifting block assembly 23 is that it does not have sharp edges, thereby preventing injuries during the set-up of the mast 2, and it allows easy rotation of the mast 2 when positioned in the field base 58, and it is easy to manufacture e.g. on a lathe. But the invention also works for other bottom elements 24 having a lower diameter at a higher position than at a lower position. Providing the fixation component 62 as a separate part allows the shape and material thereof to be optimized for optimal tightening to avoid rotation of the mast 2.

In a preferred embodiment of the lifting block assembly 23 the bottom element 24 and the fixation component 62 are both made of aluminum. To have a large contact area with the bottom element 24 and thus a good fixation, the shape of the fixation component 62 is preferably complementary to at least part of the bottom element 24. Other shapes and materials for the bottom element 24 and for the fixation component 62 can be chosen by the person skilled in the art, e.g. the sphere of the bottom element 24 could be replaced by a cylinder made out of steel.

FIGS. 6A-6C show examples of tubular mast elements 4 known in the art, comprising means for preventing disengagement of successive mast elements 4. To allow an easy, well aligned placement of the mast elements 4 on top of each other, and to prevent the mast elements 4 from disengaging, typically a cylindrical insert 53 with an outer diameter approximately equal to the inner diameter of the tubular mast elements 4 is mounted in the upper end of each tubular element 4, and extending above it, to enable insertion thereof in the lower end of the next higher tubular mast element 4 in the mast 2. Usually device mounting holes 18 are foreseen in this cylindrical insert 53, which device mounting holes 18 can be used for fixation of the equipment 8 such as e.g. an antenna, lighting, camera, microphone etc, using standard fixation means such as e.g. screws. The lower end of the tubular mast elements 54, and the higher end of the tubular mast element 55 typically have a complementary form to prevent rotation between a lower and the next higher mast element 4. As the tubular mast elements 4 can rotate inside the tubular pipe 9 of the base of the invention, and as all mast element 4 of the mast 2 cannot rotate with respect to each other, it is possible to orient the equipment 8 mounted on the mast 2 by rotating any of the mast elements 4, thereby rotating the entire mast 2. The outer diameter D of the tubular mast elements 4 typically lies between 50 and 110 mm, and can for example be 110 mm, 100 mm, 90 mm, 80 mm, 70 mm, 60 mm or 50 mm. The length of the tubular mast elements 4 without taking into account the cylindrical insert 53 is typically 1 m, which makes it easy to transport them, to insert the tubular mast elements 4 from a position below the guide shaft 3, and to determine the height of an erected mast 2 by simply counting the superimposed mast elements 4. But the tubular mast elements 4 can also have other lengths, such as e.g. 80 cm, 90 cm, 100 cm, 110 cm or 120 cm.

1. Mast assembly comprising a base and a transportable mast and a guy control assembly for stabilizing the mast during erection or retraction of the mast,
the mast comprising a plurality of tubular mast elements positioned on top of each other;
the base comprising: a guide shaft with an opening for guiding the displacement of the tubular mast elements during erection or retraction of the mast; a plurality of legs connected to the guide shaft, for positioning the guide shaft at a distance above ground to allow insertion of the tubular mast elements from a position below the guide shaft;
the guy control assembly being connected to the mast at a predefined position in at least three directions by means of at least three guy control wires, a first end of each guy control wire being connected to the mast, a second end of each guy control wire being connected to the guy control assembly;
characterised in that
each guy control wire being guided at a position between the first and second end of the guy control wire towards a ground position located at a predefined distance ER and being separate from the base, to which ground positions they are fastened or from which ground positions they are routed to a single position to permit keeping the guy control wires under tension by a single person;
the guy control assembly is portable by a single person and has at least one handle for holding the guy control assembly.

2. Mast assembly according to claim 1, wherein the ground positions are located on an imaginary circle of a predefined radius, where the base is standing in a centre of the circle.

3. Mast assembly according to claim 2, wherein the radius is chosen such that an angle between a ground surface and the guy control wires is between 45 and 60 degrees when the mast is fully erected.

4. Method according to claim 2, wherein the ground positions are lying 120 degrees apart on the imaginary circle.

5. Mast assembly according to claim 1, wherein the guy control wires are routed from the ground positions to one of the ground positions before being routed to the single position.

6. Mast assembly according to claim 1, wherein the guy control assembly comprises rope cleats for connecting the second ends of the guy control wires.

7. Mast assembly according to claim 1, wherein the guy control assembly has three handles, a left handle, a right handle and a lower handle, for holding the guy control wires under tension, or for adjusting a guy control wire.

8. Mast assembly according to claim 1, wherein the guide shaft comprises:
a tubular pipe having the opening for guiding the displacement of the tubular mast elements;
a first leg attachment collar mounted to an upper part of the tubular pipe, the first leg attachment collar being connectible to the legs at a first connection position on the legs;
the tubular pipe extending from the first leg attachment collar to a position below the first leg attachment collar to permit mounting of second connection means to the legs;
second connection means mounted to a lower part of the tubular pipe, which second connection means are connectible to the legs at a second connection position on the legs, the second connection position being spaced from the first connection position in height direction of the base;
wherein the tubular pipe is made of a first material and the first leg attachment collar is made of a second material;

9. Mast assembly according to claim 1, wherein the predefined position on the mast is located on the upper mast element.

10. Mast assembly according to claim 1, wherein the mast assembly additionally comprises a guy collar blade rotatably mounted to the mast at the predefined position, the guy collar blade having mounting holes whereto first ends of the guy control wires are connected.

11. Mast assembly according to claim 1, additionally comprising a pulley block mounted to a picket at each of the ground positions for routing the guy control wires to the single point during erection or retraction of the mast.

12. Mast assembly according to claim 1, additionally comprising guy tensioners mounted to a picket at each of the ground positions for fastening the guy control wires to a position near the ground after erection of the mast.

13. Mast assembly according to claim 1, additionally comprising equipment mounted to the mast, wherein the equipment is selected from the group of an antenna, a camera, a microphone and lighting.

14. Method for keeping a transportable mast upright during erection or retraction thereof, the mast being part of a mast assembly further comprising a base and a portable guy control assembly,
the mast comprising a plurality of tubular mast elements positioned on top of each other;
the base comprising: a guide shaft with an opening for guiding the displacement of the tubular mast elements during erection or retraction of the mast; a plurality of legs connected to the guide shaft for positioning the guide shaft at a distance above ground to allow insertion of the tubular mast elements from a position below the guide shaft;
the method comprising the steps of:
connecting first ends of at least three guy control wires to the mast at a predefined position in at least three directions;
guiding each guy control wire towards a ground position located at a predefined distance and being separate from the base, and routing them to a single position to permit keeping the guy control wires under tension by a single person;
connecting a second end of each guy control wire to the guy control assembly;
keeping the guy control wires under tension by holding the guy control assembly while moving towards resp. away from the base as the mast elements are being lifted resp. lowered.

15. Method according to claim 14, wherein the guy control wires are guided to ground positions located on an imaginary circle having a predetermined radius, where the base is standing in a centre of the circle.

16. Method according to claim 15, thereby choosing the radius such that an angle between a ground surface and the guy control wires is between 45 and 60 degrees when the mast is fully erected.

17. Method according to claim 15, comprising the step of choosing the ground positions 120 degrees apart on the imaginary circle.

18. Method according to claim 14, wherein the holding of the guy control assembly is performed by holding at least one handle of the guy control assembly.

19. Method according to claim 14, wherein the guy control assembly comprises rope cleats and the step of connecting second ends of the guy control wires to the guy control assembly is performed by connecting the second ends to the rope cleats.

20. Method according to claim 14, wherein the routing of each guy control wire to a single position comprises the step of routing the guy control wires to one of the ground positions before routing them to the single position.

21. Method according to claim 14, wherein the guide shaft comprises:
a tubular pipe having the opening for guiding the displacement of the tubular mast elements;
a first leg attachment collar mounted to an upper part of the tubular pipe, the first leg attachment collar being connectible to the legs at a first connection position on the legs;
the tubular pipe extending from the first leg attachment collar to a position below the first leg attachment collar to permit mounting of second connection means to the legs;
second connection means mounted to a lower part of the tubular pipe, which second connection means are connectible to the legs at a second connection position on the legs, the second connection position being spaced from the first connection position in height direction of the base;
wherein the tubular pipe is made of a first material and the first leg attachment collar is made of a second material;

22. Method according to claim 14, wherein the step of connecting the first ends of the guy control wires to the mast at a predefined position is performed by connecting the first ends to the upper mast element.

23. Method according to claim 14, wherein the method further comprises a step of rotatably mounting a guy collar blade to the mast at the predefined position, the guy collar blade having mounting holes, and connecting the first ends of the guy control wires to the mounting holes.

24. Method according to claim 14, wherein the step of guiding and routing the guy control wires comprises mounting a pulley block to a picket at each of the ground positions and routing the guy control wires through the pulley blocks.
